(19) United States
(12) Patent Application Publication
(10) Pub. No.: US 2018/0065732 A1
(43) Pub. Date: Mar. 8, 2018

(54) FLUIDIC ACTUATOR HAVING JET VECTOR CONTROL AND FLOW BODY

(71) Applicant: AIRBUS DEFENCE AND SPACE GMBH, Taufkirchen (DE)

(72) Inventors: Michael Meyer, Munich (DE); Matthias Bauer, Berlin (DE)

(21) Appl. No.: 15/689,697

(22) Filed: Aug. 29, 2017

(30) Foreign Application Priority Data
Sep. 5, 2016 (EP) 16 187 248.6

(51) Int. Cl. B64C 21/02; B64C 9/16; B64C 5/02

(52) U.S. Cl. CPC B64C 21/025; B64C 5/02; B64C 9/16

(57) ABSTRACT

A fluidic actuator for influencing a flow of a surrounding fluid along a flow surface has a blowing duct for connecting to a pressurized-fluid source, and has a surface blowing opening formed in the flow surface, and a suction duct for connecting to a surface suction opening formed in the flow surface, wherein the suction duct flows into the blowing duct at an entrainment opening.

### CROSS-REFERENCE TO RELATED APPLICATION

This application claims priority to European Patent Application EP 16 187 248.6 filed Sep. 5, 2016, the entire disclosure of which is incorporated by reference herein.

### TECHNICAL FIELD

The present disclosure relates to a fluidic actuator and to a flow body, in particular for an aircraft.

Although it is possible to use surfaces around which fluid flows for many different applications, the present disclosure and the problem on which it is based will be explained in more detail with reference to aircraft surfaces around which fluid flows.

### BACKGROUND

To control the separation of boundary layers on bodies with fluid flowing around them, in particular on airfoils of aircraft, pulses of compressed air are often blown onto the surface of the body around which the fluid flows. This is used to energize the boundary layer, thus preventing the boundary layer from separating and achieving favorable pressure distribution along the surface resulting in better lift and lower flow resistance of the flow body.

EP 2 650 213 A1 discloses a flow body comprising a fluidic actuator. The fluidic actuator comprises a blowing duct connected to an opening formed in a flow surface of the flow body and to a compressed air source. By a control pressure variation device, pulses of a pressurized fluid provided by the compressed air source can be produced through the openings in the flow surface.

The blowing ducts of this kind of fluidic actuator usually have to be positioned within the cross section of the flow body. This limits the available installation space. The flow direction of the pressurized fluid blown out, defined by both the course of the blowing duct and the openings in the flow surface, is thus often determined by structural conditions. In particular, it is often necessary to find a compromise between requirements in terms of fluid mechanics and structural requirements.

### SUMMARY

An idea of the present disclosure is to provide a fluidic actuator by which the fluid-mechanics properties of a flow body are improved and which can be easily integrated in the flow body.

Another idea of the present disclosure is to provide a flow body that is improved in terms of fluid mechanics.

According to a first aspect of the disclosure herein, a fluidic actuator for influencing a flow of a surrounding fluid along a flow surface is provided. The fluidic actuator comprises a blowing duct having an intake opening provided at its first end for connecting to a pressurized-fluid source, and a blowing opening provided at its second end for connecting to a surface blowing opening formed in the flow surface. Furthermore, the fluidic actuator comprises a suction duct having a suction opening provided at its first end for connecting to a surface suction opening which is formed in the flow surface and arranged at a distance from the surface blowing opening in a flow direction of the surrounding fluid. At its second end, the suction duct flows into the blowing duct at an entrainment opening provided or disposed between the first end of the blowing duct and the second end of the blowing duct.

According to an embodiment of the disclosure herein, therefore, a fluidic actuator having both a blowing duct for blowing a pressurized fluid at a flow surface and a suction duct for sucking fluid at the flow surface is provided. In particular, the suction duct flows into the blowing duct at an entrainment opening or recirculation opening, and is thus connected to the blowing duct so as to conduct fluid. This design causes a mass flow of the pressurized fluid through the blowing duct and suction of fluid found in the suction duct into the blowing duct. This is referred to as “entrainment”. The pressurized fluid can thus be transported through the blowing duct and blown out through a surface blowing opening in the flow surface in order to influence the flow. At this opening, the mass flow exits as a jet at a jet exit angle relative to the flow surface. The described design of the fluidic actuator causes suction of fluid, i.e. the generation of negative pressure at the suction opening of the suction duct or surface suction opening, at a suction opening of the suction duct, which opening can be connected to a surface suction opening in the flow surface, by fluid being sucked out of the suction duct into the blowing duct as a result of the flow of the pressurized fluid through the suction duct. The negative pressure generated changes the jet exit angle of the exiting pressurized-fluid jet. In particular, the pressurized-fluid jet is deflected towards the surface suction opening. Therefore, the actual jet exit angle of the pressurized fluid is decoupled from the geometric exit angle determined by the course of the blowing duct or surface blowing opening as a result of the recirculation of the suction duct into the blowing duct of the fluidic actuator. Therefore, the blowing duct and the suction duct of the fluidic actuator can be positioned within a flow body in a space-saving manner. By the fluidic actuator, therefore, a jet vector control is produced, i.e. a targeted, variable adjustment of the flow direction of the pressurized-fluid jet. At the same time, the suction of fluid at the flow surface makes it possible to influence the jet exit angle of the pressurized fluid blown out at the flow surface in a targeted manner adapted to the fluid-mechanics conditions. Since the suction is brought about by entrainment as a result of the suction duct flowing into the blowing duct, no additional suction components are required. This creates a compact, space-saving design and reduces the weight of the fluidic actuator. The design of the fluidic actuator also means that no movable components are required to generate the negative pressure at the flow surface. This is a significant advantage in terms of the reliability and maintenance of the fluidic actuator.

According to another development of the fluidic actuator, the entrainment opening faces the blowing opening. The suction duct thus flows into the blowing duct at an angle of less than or equal to 90° to the longitudinal extension of the blowing duct. The flow into the duct can be approximately tangential. This reduces flow losses in the region of the entrainment opening and increases the efficiency of the entrainment.

Furthermore, between the entrainment opening and the blowing opening the blowing duct has a cross section that is greater than a cross section of the blowing duct between the intake opening and the entrainment opening. According to this development, the cross-sectional area of the suction duct is increased downstream of the entrainment opening in relation to a flow direction from the supply opening to the blowing opening of the suction duct. As a result, the flow rate of the mass flow, which is greater as a result of the entrainment out of the suction duct, can be controlled and thus any possible flow losses reduced.

According to a further embodiment of the fluidic actuator, a central body forms a blowing duct wall extending between the entrainment opening and the blowing opening of the blowing duct, and a suction duct wall. In particular, the central body is arranged between the blowing duct and the suction duct, and its opposite surfaces define each duct. This gives the fluidic actuator a particularly compact design. It also creates a high degree of freedom in the design of the surfaces of the central body that define the ducts, meaning the ducts can be produced having an extension in terms of flow losses in a simple and space-saving manner.

According to another embodiment, the fluidic actuator additionally comprises a supply variation device, by which a supply of a pressurized fluid, provided by the pressurized-fluid source, into the blowing duct can be controlled, the intake opening of the blowing duct being connected to an output of the variation device and it being possible to connect an inlet of the variation device to the pressurized-fluid source. The supply variation device in particular forms a control device for the pressurized-fluid mass flow being supplied to the blowing duct. The device can make it possible to blow out different mass flows depending on the fluid-mechanics requirements for the flow of a surrounding fluid along the flow surface.

The supply variation device can be designed such that the supply of the pressurized fluid into the blowing duct can be stopped periodically. This means that the pressurized fluid can be blown out in pulses, making it possible to introduce eddy structures into the flow of the surrounding fluid in a particularly effective manner, in order to prevent flow separation.

According to a second aspect of the present disclosure, a flow body comprising a flow surface over which a surrounding fluid is intended to flow in a flow direction is provided. The flow body comprises a fluidic actuator having a blowing duct having an intake opening provided at its first end for connecting to a pressurized-fluid source, and a blowing opening provided at its second end, which opening is connected to a surface blowing opening formed in the flow surface. The flow body also comprises a suction duct having a suction opening that is provided at its first end and connected to surface suction opening that is formed in the flow surface and arranged at a distance from the surface blowing opening in a flow direction of the surrounding fluid, the suction duct flowing, at its second end, into the blowing duct at an entrainment opening provided or disposed between the first end of the blowing duct and the second end of the blowing duct.

A flow body comprising a fluidic actuator is thus provided. The fluidic actuator can in particular be designed according to one of the aforementioned embodiments.

By the aforementioned option to decouple the geometric exit angle for the blowing duct or surface blowing opening in the flow body from the actual jet exit angle of the pressurized fluid that can be blown through the surface blowing opening, the fluidic actuator can be integrated in the flow body. In particular, mechanical strength requirements and fluid-mechanics requirements on the flow body can thus be taken into account at the same time and separately from one another. In particular, the fluid-mechanics properties of the flow body can be improved by the adjustability of the jet exit angle as a result of the suction duct of the fluidic actuator being connected to the surface suction opening in the flow body.

According to another development, the surface suction opening is arranged downstream of the surface blowing opening in relation to the flow direction of the surrounding fluid. In this way, the jet exit angle of the pressurized-fluid jet is reduced in relation to the flow direction, because of the deflection of the pressurized-fluid jet exiting from the surface blowing opening towards the surface suction opening. This allows the fluidic actuator to be integrated such that the blowing duct extends approximately perpendicularly or generally transversely to the flow surface, which is advantageous in terms of integrating the fluidic actuator in the flow body in a mechanically robust manner.

According to an alternative embodiment of the flow body, the surface suction opening is arranged upstream of the surface blowing opening in relation to the flow direction. As a result, the pressurized-fluid jet that can be blown out of the surface blowing opening can exit at a steeper angle relative to the flow direction of the surrounding fluid. This allows the fluidic actuator to be integrated such that the blowing duct extends approximately in parallel with or generally along the flow surface. This is particularly favorable in terms of integrating the fluidic actuator in very thin flow bodies having little available space.

According to another development of the flow body, a central axis of the blowing duct produced in the region of the blowing opening of the blowing duct forms an acute angle with a tangent produced on the flow surface at the site of the surface blowing opening. An acute angle can make influencing the surrounding flow particularly effective.

The acute angle between the central axis of the blowing duct and the tangent at the flow surface can be between 85° and 5°. Within this range, the surface blowing openings can be formed in the flow surface in a simple manner in terms of production. The acute angle can be between 60° and 15°. In this angular range, the flow of the surrounding fluid can be influenced in a particularly effective manner.

According to a third aspect of the disclosure herein, an airfoil for an aircraft is provided, comprising at least one flow body according to any of the aforementioned embodiments, the intake opening of the blowing duct of the fluidic actuator being connected to a pressurized-fluid source. When using the flow body as an airfoil component of an aircraft airfoil, the favorable properties thereof in terms of fluid mechanics because of the fluidic actuator, as well as the low weight thereof as a result of the simple design of the fluidic actuator, are particularly advantageous. In particular, the flow body can also be formed having particularly high mechanical stability because of the degree of structural design freedom provided by the fluidic actuator.

In this case, at least one flow body forms one of the airfoil components of the group consisting of or comprising the leading edge flap, trailing edge flap, main wing body, stabilizer and elevator. Because of the design of the fluidic actuator, there is a large structural play when integrating the actuator in the flow body, as set out above. This provides the advantage whereby the flow around a huge range of airfoil components of an aircraft can be influenced separately and effectively. In particular, the fluidic actuator also makes it possible to influence the flow even in relatively narrow airfoil regions or in those having a small cross-sectional thickness, e.g. the trailing edges of airfoils.

In this document, where directional details and axes are concerned, in particular directional details and axes relating to the course of physical structures, a course of an axis, direction or structure “along” another axis, direction or structure should be taken to mean that these, in particular the tangents produced at a given point on the structures, extend in each case at an angle of less than 45° to one another, for example less than or equal to 30°, and for example in parallel with one another.

In this document, where directional details and axes are concerned, in particular directional details and axes relating to the course of physical structures, a course of an axis, direction or structure “transversely to” another axis, direction or structure should be taken to mean that these, in particular the tangents produced at a given point on the structures, extend in each case at an angle of greater than or equal to 45° to one another, for example greater than or equal to 60°, and for example perpendicularly to one another.

Where “one-piece”, “single-piece”, “integral” components or components “in one piece” are mentioned, these should generally be taken as being present as a single part forming a material unit, and in particular as having been produced as such, it being impossible to detach one component from the other without destroying the material bond.

### BRIEF DESCRIPTION OF THE DRAWINGS

The disclosure herein will be described hereinafter with reference to the drawings, in which:

FIG. 1 is a schematic view of a flow body according to an embodiment of the present disclosure;

FIG. 2 is a schematic view of a fluidic actuator according to an embodiment of the present disclosure, in the form of a detailed view of the region of the flow body shown in FIG. 1 labelled with the letter Z;

FIG. 3 is a schematic view of the flow conditions during operation of the fluidic actuator or flow body shown in FIG. 2;

FIG. 4 is a schematic view of a fluidic actuator according to another embodiment of the present disclosure, in the form of a detailed view of a flow body according to another embodiment of the present disclosure;

FIG. 5 is a schematic view of the flow conditions during operation of the fluidic actuator or flow body shown in FIG. 4; and

FIG. 6 is a schematic view of an aircraft comprising an airfoil according to an embodiment of the present disclosure.

In the drawings, the same reference numerals denote like components or those with the same function, unless specified otherwise.

### DETAILED DESCRIPTION

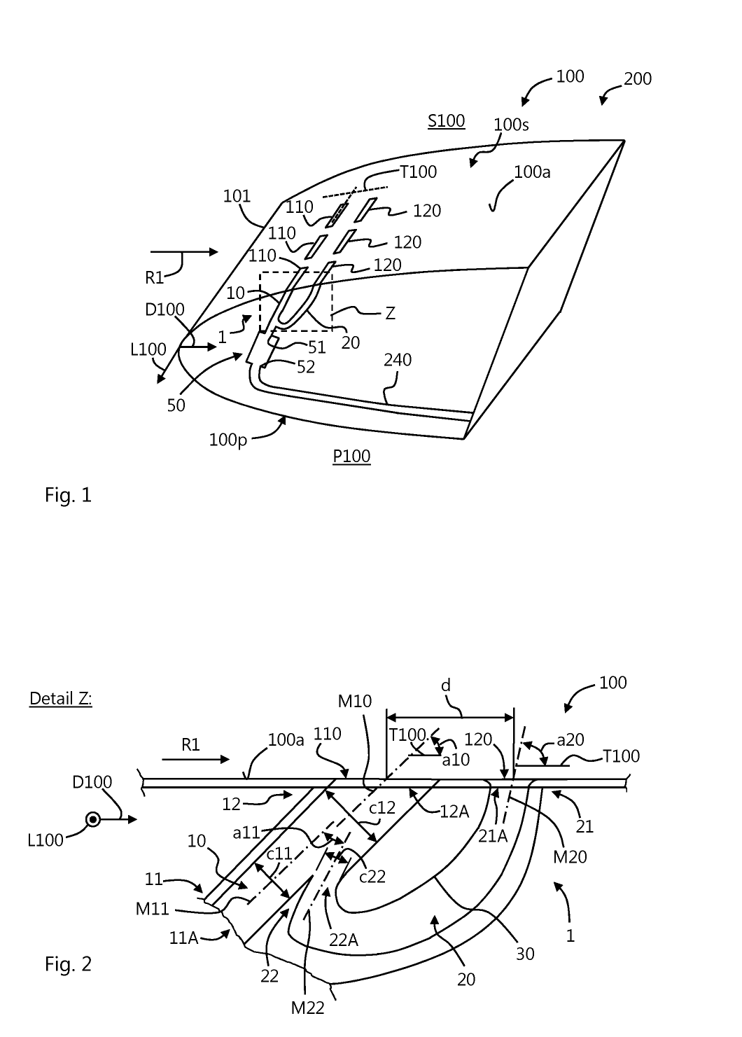

By way of example, FIG. 1 is a schematic view of a flow body 100 comprising a fluidic actuator 1. The flow body 100 comprises a flow surface 100a over which a surrounding fluid is intended to flow. FIG. 1 shows an example design of the flow body 100 as an airfoil component of an airfoil 200 of an aircraft 250. As shown in FIG. 1, the flow body 100 can in particular comprise a leading edge 101 that extends in a flow body longitudinal direction L100 and forms a leading end of the flow body 100 in relation to a flow direction R1 of the surrounding fluid. The flow surface 100a can in particular comprise a first surface region 100s defining a suction side S100 of the flow body 100, and a second surface region 100p defining a pressure side P100 of the flow body 100.

The flow body 100 also comprises at least one surface blowing opening 110 formed in the flow surface 100a. In particular, a plurality of surface blowing openings 110 can be arranged one behind the other in the flow body longitudinal direction L100. In the flow body 100 shown by way of example in FIG. 1, the surface blowing openings 110 are formed in the first, suction-side surface region 100s. It goes without saying that the surface blowing openings 110 can alternatively or additionally be arranged in the second, pressure-side surface region 100p too.

In addition to the surface blowing openings 110, the flow body 100 comprises at least one surface suction opening 120. In particular, a plurality of surface suction openings 120 can be arranged one behind the other in the flow body longitudinal direction L100. The surface suction openings 120 are arranged at a distance from one another in relation to a flow body depth direction D100 extending transversely to the flow body longitudinal direction L100. In FIG. 1, the surface suction openings 120 are arranged downstream of the surface blowing openings 110 in relation to the flow direction R1 of the surrounding fluid or in relation to the flow body depth direction D100. However, the surface suction openings 120 can also be arranged between the leading edge 101 and the surface blowing openings 110, i.e. upstream of the surface blowing openings 110 in relation to the flow direction R1 of the surrounding fluid or in relation to the flow body depth direction D100, as shown by way of example in FIG. 4.

FIG. 1 shows the surface blowing openings 110 and the surface suction openings 120, in each case by way of example, as elongate slots extending in the flow body longitudinal direction. The slots can have a rectangular shape.

As shown schematically in FIG. 1, the fluidic actuator 1 comprises a blowing duct 10 and a suction duct 20. The fluidic actuator 1 can optionally also comprise a supply variation device 50. The fluidic actuator 100 can be connected to a pressurized-fluid source 240 (only shown schematically in FIG. 1). When the fluidic actuator 1 is fitted in the flow body 100 as shown in FIG. 1, the blowing duct 10 is connected to the surface blowing opening 110 and the suction duct 20 is connected to the surface suction opening 120.

FIGS. 2 and 4 each show an enlarged detail of a fluidic actuator 1. The fluidic actuator 1 is intended to influence the flow of the surrounding fluid along the flow surface 100a of the flow body 100. In the process, the flow is influenced in particular by blowing a pressurized fluid out of the surface blowing opening 110, as a result of which eddies are introduced into a boundary layer region of the flow located close to the surface. These eddies ensure that the boundary layer region and a high-energy outer region of the flow are thoroughly mixed. This gives the boundary layer region energy and prevents the flow separating from the flow surface 100a.

As shown in FIGS. 2 and 4, the fluidic actuator 1 comprises a blowing duct 10 having an intake opening 11A provided at its first end 11 and a blowing opening 12A provided at its second end 12. The intake opening 11A is intended to be connected to the pressurized-fluid source 240. As shown in FIGS. 2 and 4, the blowing opening 12A is connected to the surface blowing opening 110 when the fluidic actuator 1 is fitted in the flow body 100. In FIGS. 1, 2 and 4, the blowing duct 10 is shown as a duct extending substantially straight, it also being possible for the duct to have a curved course. In the region where the blowing duct 10 is connected to the surface blowing opening 110, a central axis M10 of the blowing duct 10 produced in the region of the blowing opening 12A of the blowing duct 10 can form an acute angle a10 with a tangent T100 produced on the flow surface 100a at the site of the surface blowing opening 110. The tangent T100 is produced in particular in a portion of the flow surface 100a that is aligned with the surface blowing opening 110 in relation to the flow body longitudinal direction L100, as shown schematically in FIG. 1. The central axis M10 of the blowing duct 10 can in particular be defined as an axis that extends through the centres of area of the cross-sectional areas of the blowing duct 10 that are produced along the longitudinal extension of the blowing duct 10.

The angle a10 can be between 85° and 5°. Within this range, the surface blowing openings 110 can be formed in the flow surface 100a in a simple manner in terms of production. For example, the angle is between 60° and 15°. In this angular range, the flow of the surrounding fluid can be influenced in a particularly effective manner.

As also shown in FIGS. 2 and 4, the fluidic actuator 1 comprises a suction duct 20 having a suction opening 21A provided at its first end 21. When the fluidic actuator 1 is integrated in the flow body 100 as shown in the drawings, the suction opening is connected to the surface suction opening 120. At its second end 22, the suction duct 20 flows into the blowing duct 10 at an entrainment opening 22A provided or disposed between the first end 11 of the blowing duct 10 and the second end 12 of the blowing duct 10. The suction duct 20 thus connects the flow surface 100a and the blowing duct 10 to enable fluid communication. In particular, the suction duct 20 forms a recirculation line for recirculating the surrounding fluid from the flow surface 100a into the blowing duct 10.

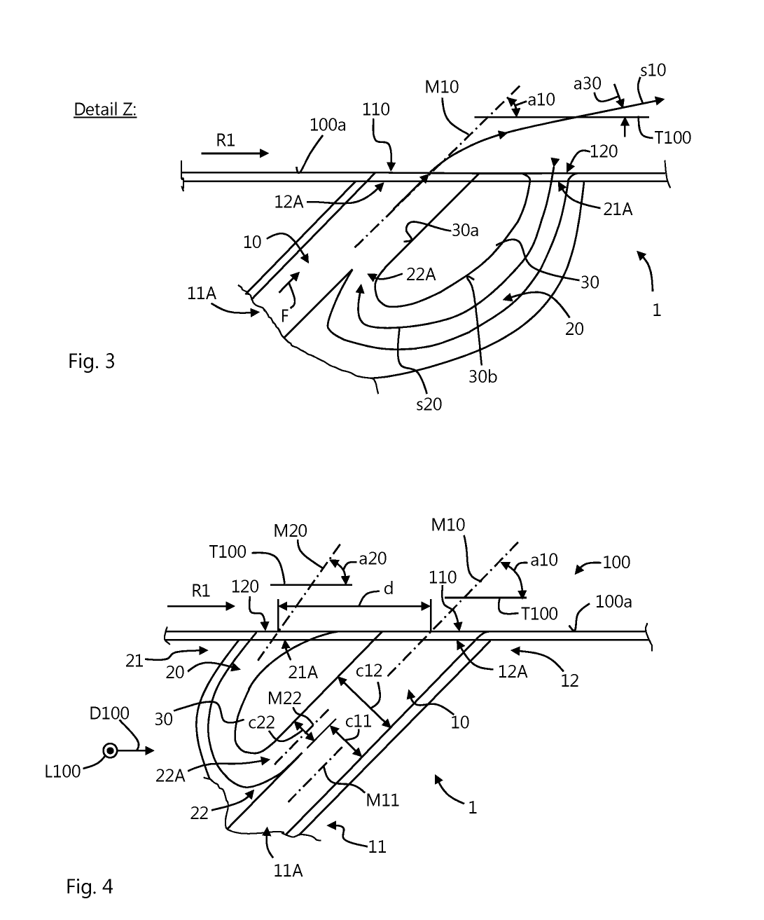

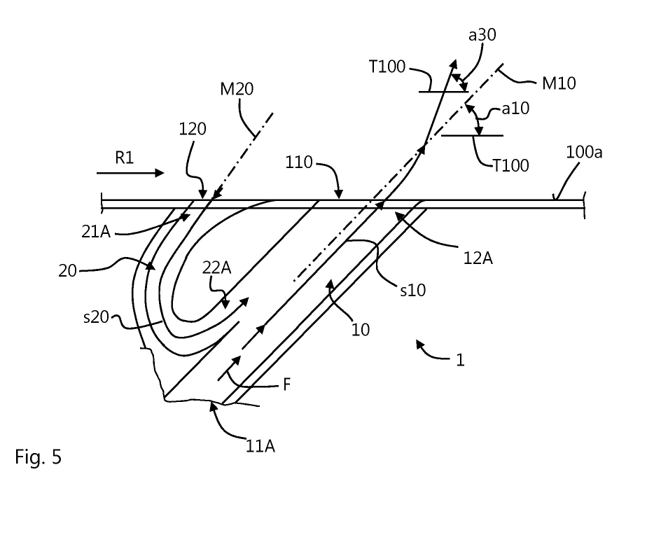

Since the suction duct 20 flows into the blowing duct 10 at the entrainment opening 10, a pressurized-fluid mass flow flowing in a pressurized-fluid flow direction F from the first end 11 of the blowing duct 10 to the second end 12 of the blowing duct 10 causes fluid in the suction duct 20 to be sucked into the blowing duct 10. This “entrainment” of fluid found in the suction duct 20 leads to a mass flow of fluid through the suction duct 20 from the surface suction opening 120, to which the suction opening 21A of the suction duct 20 is connected, to the entrainment opening 22A. This is shown schematically in FIGS. 3 and 5 by the flow line s20. Because of the mass transport 20, the pressure is lowered locally in one region around the surface suction opening 120. The jet, exiting through the surface blowing opening 110, of pressurized fluid flowing through the blowing duct 10 is thus deflected. This is shown schematically in FIGS. 3 and 5 by the flow line s10. By fluid being sucked into the suction duct 20, the jet of pressurized fluid blown out of the surface blowing opening 110 is deflected towards the surface suction opening 120. As a result, an exit angle a30 of the jet, produced between the tangent T100 at the flow surface 100a and the jet of the pressurized fluid blown out of the surface blowing opening 110, is decoupled from the geometric angle a10, resulting from the course of the blowing duct, between the central axis M10 of the blowing duct 10 and the tangent T100. In the configuration of the flow body 100 shown in FIG. 3, in which the surface suction opening 120 is positioned downstream of the surface blowing opening 110 in relation to the flow direction R1, the exit angle a30 of the jet is reduced compared with the geometric angle a10. In the configuration of the flow body 100 shown in FIG. 5, in which the surface suction opening 120 is positioned upstream of the surface blowing opening 110 in relation to the flow direction R1, the exit angle a30 of the jet is increased compared with the geometric angle a10.

As shown in FIGS. 2 and 4, a central axis M20 of the suction duct 20, produced in the region of the suction opening 21A, forms an acute angle a20 with the tangent T100 in the region where the suction duct 20 is connected to the surface suction opening 120. This geometric angle a20 can be in a range between 5° and 85°.

As can be seen in particular in FIGS. 2 and 4, the surface blowing opening 110 and the surface suction opening 120 are arranged at a distance d from one another in the flow body longitudinal direction L100.

FIGS. 2 and 4 show an example course of the suction duct 20 in the region of its second end 22. In this case, the suction duct 20 extends in the region of the second end 22 in such a way that the entrainment opening 22A faces the blowing opening 12A. In particular, the central axis M22 of the suction duct 20, produced in the region of the entrainment opening 22A, forms an angle a11 of less than or equal to 90° with the central axis M11 of the blowing duct 10 produced in the region of the entrainment opening 22A, as shown by way of example in FIG. 2, or extends in parallel therewith, as shown in FIG. 4.

As shown in particular in FIGS. 2 and 4, between the entrainment opening 22A and the blowing opening 12A the blowing duct 10 can have a cross section c12 that is larger than a cross section c11 of the blowing duct 10 between the intake opening 11A and the entrainment opening 22A. In FIGS. 2 and 4, the cross sections c11 and c12 are both shown as diameters of the blowing duct. The cross section of the duct should thus be understood as a cross-sectional area of the duct, defined by the walls of the duct. As also shown in FIGS. 2 and 4, the entrainment opening 22A has a cross-sectional area c22 that can be smaller than the cross section c11 of the blowing duct 10 between the intake opening 11A and the entrainment opening 22A.

By adapting the parameters of the group consisting of or comprising the angle a10, the angle a20, the cross section c11, the cross section c12, the cross section c22 and the distance d, the exit angle a30 of the jet of the pressurized fluid blown out of the blowing opening 10 can be adjusted effectively.

In addition, a central body 30 arranged between the blowing duct 10 and the suction duct 20 can be provided, as shown in particular in FIGS. 2 and 4. By a first surface 30a, the central body 30 forms a wall of the blowing duct 10 in the region between the entrainment opening 22A and the blowing opening 12A. In particular, the first surface 30a of the central body 30 forms a part of the wall that defines the cross section c12 of the blowing duct 10 between the entrainment opening 22A and the blowing opening 12A. By a second surface 30b, the central body 30 forms a wall of the suction duct 20, in particular a part of a wall that defines the cross section of the suction duct 20. The first surface 30a of the central body 30 can extend in a planar manner, as can be seen in particular in FIG. 3; in particular the surface can have only a curve in one curve direction. The second surface 30b can in particular have a curved course, as shown in FIG. 3, and can thus define in a simple manner a course of the suction duct 20 that is advantageous in terms of flow losses.

The central body 30 can in particular be designed as a hollow body, thereby reducing its weight. In particular, the central body 30 can be formed in one piece with, or be connected to, the structures or walls forming the suction duct 20 and/or the structure or walls forming the blowing duct 10. In addition, the central body 30 can be formed in one piece with, or be connected to, the structures or walls forming the flow surface 100a.

By the optional supply variation device 50 shown schematically in FIG. 1, it is possible to control a supply, in particular a mass flow, into the blowing duct 10 of the pressurized fluid provided by the pressurized-fluid source 240. A design of this control provides for the mass flow of the pressurized fluid to be periodically stopped. In this case, the intake opening 11A of the blowing duct 10 is connected to an outlet 51 of the variation device 50 and an inlet 52 of the variation device 50 can be connected to the pressurized-fluid source 240.

FIG. 1 shows the flow body 100 as a part of an airfoil 200 by way of example, the intake opening 11A being connected to a pressurized-fluid source 240. In particular, the intake opening 11A is connected to the outlet 51 of the variation device 50 and the inlet 52 of the variation device 50 is connected to the pressurized-fluid source 240. As a result, a pressurized-fluid mass flow can be conducted into the blowing duct 10.

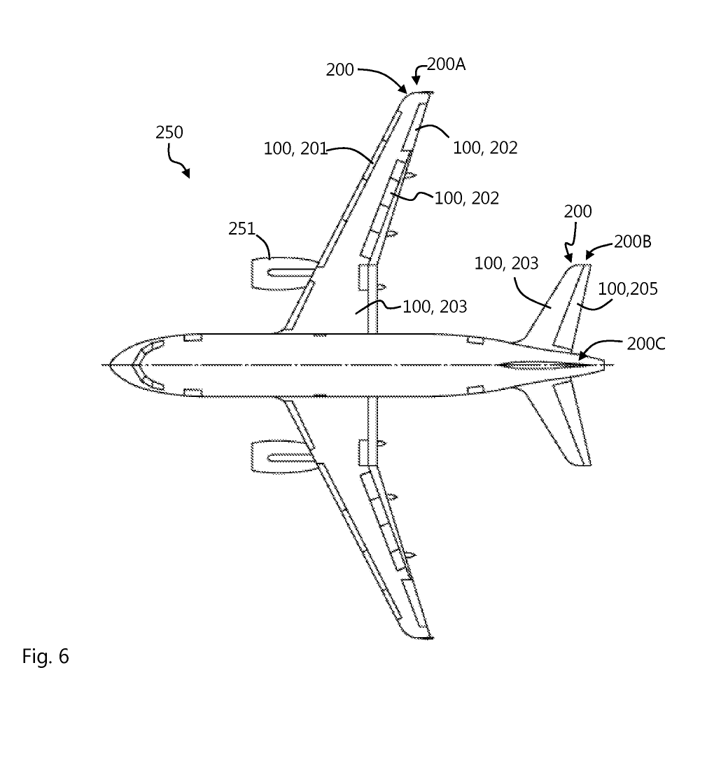

By way of example, FIG. 6 shows an airfoil 200 for an aircraft 250, comprising at least one flow body 100, the intake opening 11A being connected to a pressurized-fluid source 240. In this case, the pressurized-fluid source 240 can in particular be formed by a bleed air outlet (not shown) of an engine 251 of the aircraft 250.

As FIG. 6 also shows, the airfoil 200 can be formed by a wing 200A, an elevator 200B or a rudder 200C. In this case, the flow body 100 can form a leading edge flap 201, a trailing edge flap 202 or a main wing body 203, for example.

Although the present disclosure has been explained by way of example above on the basis of embodiments, it is not limited thereto; instead it can be modified in many different ways. In particular, combinations of the above embodiments are also conceivable.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fluidic actuator for influencing a flow of a surrounding fluid along a flow surface, comprising:
a blowing duct comprising an intake opening at a first end of the blowing duct for connecting to a pressurized-fluid source, and a blowing opening at a second end of the blowing duct for connecting to a surface blowing opening formed in the flow surface; and
a suction duct comprising a suction opening at a first end of the suction duct for connecting to a surface suction opening which is formed in the flow surface and is arranged at a distance from the surface blowing opening in a flow direction of the surrounding fluid,
the suction duct flowing, at a second end of the suction duct, into the blowing duct at an entrainment opening disposed between the first end of the blowing duct and the second end of the blowing duct.

2. The fluidic actuator of claim 1, wherein the entrainment opening faces the blowing opening.

3. The fluidic actuator of claim 1, wherein between the entrainment opening and the blowing opening the blowing duct is configured to have a cross section that is larger than a cross section of the blowing duct between the intake opening and the entrainment opening.

4. The fluidic actuator of claim 1, wherein a central body forms a wall of the blowing duct, which wall extends between the entrainment opening and the blowing opening of the blowing duct, and forms a wall of the suction duct.

5. The fluidic actuator of claim 1, further comprising:
a supply variation device, by which it is possible to control, in particular periodically stop, a supply into the blowing duct of pressurized fluid provided by the pressurized-fluid source, wherein the intake opening of the blowing duct is connected to an outlet of the variation device and an inlet of the variation device is connectable to the pressurized-fluid source.

6. A flow body comprising a flow surface over which a surrounding fluid is intended to flow in a flow direction, comprising a fluidic actuator comprising:
a blowing duct comprising an intake opening provided at a first end of the blowing duct for connecting to a pressurized-fluid source, and a blowing opening provided at a second end of the blowing duct, which opening is connected to a surface blowing opening formed in the flow surface; and
a suction duct comprising a suction opening at a first end of the suction duct and connected to the surface suction opening formed in the flow surface and arranged at a distance from the surface blowing opening in a flow direction of the surrounding fluid, the suction duct flowing, at a second end of the suction duct, into the blowing duct at an entrainment opening provided between the first end of the blowing duct and the second end of the blowing duct.

7. The flow body of claim 6, wherein the surface suction opening is arranged downstream of the surface blowing opening in relation to the flow direction.

8. The flow body of claim 6, wherein the surface suction opening is arranged upstream of the surface blowing opening in relation to the flow direction.

9. The flow body of claim 6, wherein a central axis of the blowing duct produced in a region of the blowing opening of the blowing duct forms an acute angle with a tangent produced on the flow surface at a site of the surface blowing opening.

10. The flow body of claim 9, wherein a central axis of the blowing duct produced in the region of the blowing opening of the blowing duct forms an angle between 85° and 5°.

11. The flow body of claim 9, wherein a central axis of the blowing duct produced in the region of the blowing opening of the blowing duct forms an angle between 60° and 15°.

12. An airfoil for an aircraft, comprising at least one flow body, the at least one flow body comprising:
a flow surface over which a surrounding fluid is intended to flow in a flow direction, comprising a fluidic actuator comprising:
a blowing duct comprising an intake opening at a first end of the blowing duct for connecting to a pressurized-fluid source, and a blowing opening at a second end of the blowing duct, which opening is connected to a surface blowing opening formed in the flow surface; and
a suction duct comprising a suction opening at a first end of the suction duct and connected to the surface suction opening that is formed in the flow surface and is arranged at a distance from the surface blowing opening in a flow direction of the surrounding fluid, the suction duct flowing, at a second end of the suction duct, into the blowing duct at an entrainment opening that is between the first end of the blowing duct and the second end of the blowing duct,
wherein the intake opening of the blowing duct of the fluidic actuator is connected to a pressurized-fluid source.

13. The airfoil of claim 12, wherein at least one flow body forms the leading edge flap.

14. The airfoil of claim 12, wherein at least one flow body forms the trailing edge flap.

15. The airfoil of claim 12, wherein at least one flow body forms the main wing body.

16. The airfoil of claim 12, wherein at least one flow body forms the stabilizer.

17. The airfoil of claim 12, wherein at least one flow body forms the elevator.
